(19) United States
(12) Patent Application Publication
(10) Pub. No.: US 2009/0250565 A1
(43) Pub. Date: Oct. 8, 2009

(54) Fully adjustabel arm rest designed for use in the tattoo industry, to support a clients arm, leg or foot during application of a tattoo

(76) Inventors: William M. Jaggers, Marseilles, IL (US); Dawn L. Jaggers, Marseilles, IL (US)

Correspondence Address: WILLIAM M. JAGGERS, 2865 E. 2369TH ROAD, MARSEILLES, IL, 61341, US

(21) Appl. No.: 11/827,938

(22) Filed: Apr. 3, 2008

(51) Int. Cl. F16M 11/26; F16M 13/00

(52) U.S. Cl. 248/125.8; 248/166

(57) ABSTRACT

This design is the first of its kind. It can be used for the arm, hand, leg, foot, neck, chest, back and ribs. The swivel rotates 360 degrees and allows the pad to be locked in at any angle. Along with the vertical slide, it can be set at a comfortable height and with the incremental adjustment of one vertical leg it can be lowered to a comfortable position. If needed, horizontal legs are easy to remove and allow it set closer to a chair. Swivel head assembly and legs are removable which make this arm rest easy to pack for transport.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

Any Devices manufactured or altered for use as an Arm Rest in the Tattoo industry have been very basic. Some allow for Vertical Adjustment with a stationary Arm Rest Pad, others have Vertical Adjustment with minimal tilting of the Arm Rest Pad and all have a Base that is either, very heavy or the shape is poorly designed. This design of arm rest has made it difficult to position a Client's Arm, Leg, or Foot. It is uncomfortable for the Client and Artist as well.

Several draw backs to older Arm Rest Designs are as follows. The inability to lower the device to a level that is comfortable for Client's to rest their foot comfortably on the Pad during the application of a Tattoo. The Pad doesn't rotate 360 degrees or tilt, which would allow for perfect placement of a Client's Arm or Leg. The Base won't expand wide enough to place the Arm Rest close to the Client's chair.

It's apparent that in the past no one in the industry has felt the need to address this problem and correct it. This Fully Adjustable Arm Rest will correct afore mentioned issues with two forms of vertical adjustment, a swivel which will allow any position of pad and a wider base.

### SUMMARY OF INVENTION

This arm rest provides full vertical adjustments in two ways. The center slide which supports the Ball Swivel and Pad assembly will slide up or down to achieve desired height. It can then be securely locked in place with a hardened threaded device.

The supporting leg structure is designed to adjust vertical height of the base in graduated increments and securely lock in place with a steel pin.

Ball swivel and pad assembly will rotate 360 degrees and securely lock in place. Ball swivel is designed to angle to any position necessary for proper placement of arm, leg or foot. This also securely locks in place with a threaded hardened device which applies pressure to the hardened ball in the swivel mechanism. The lower horizontal stabilizing legs are designed to be removable. With this design, vertical adjustments can be collapsed, ball swivel assembly is removed and entire arm rest can be easily transported in luggage or canvas bag.

### BRIEF DESCRIPTION OF DRAWINGS

FIG. 1 is a view of arm rest in its entirety and shows how the horizontal leg extensions are removable.

FIG. 2 demonstrates the rotation of pad with the inventive swivel design.

FIG. 3 is a side view of the center vertical leg.

FIG, 4 is a flat view of steel plate, with holes drilled to join center and adjustable vertical legs once it is formed.

FIG. 5 is front view of center vertical leg with plate formed and installed to accept the vertical adjustable leg. It also illustrates, in more detail how horizontal stabilizing leg is assembled.

FIG. 6 is the square tube which will slide into FIG. 8 for increased vertical adjustment.

FIG. 7 is the flat plate FIG. 4 after being formed to fit around top of FIG.8, the vertical center leg.

FIG. 8 is an angled view of the center vertical leg showing how FIG. 7 is placed. Also shows horizontal legs installed.

FIG. 9 shows assembly of increment adjustable vertical leg.

FIG. 10 is view of ball swivel assembly.

FIG. 11 is top view of assembled bracket that mounts to bottom of pad.

FIG. 12 is end view of FIG. 12

FIG. 13 is side view of FIG. 11 and illustrates the holes to be bored for steel plate and wood base for pad.

FIG. 14 shows assembly of swivel FIG. 10, with bracket for pad and pad assembly.

### DESCRIPTION OF THE PREFERRED EMBODIMENT

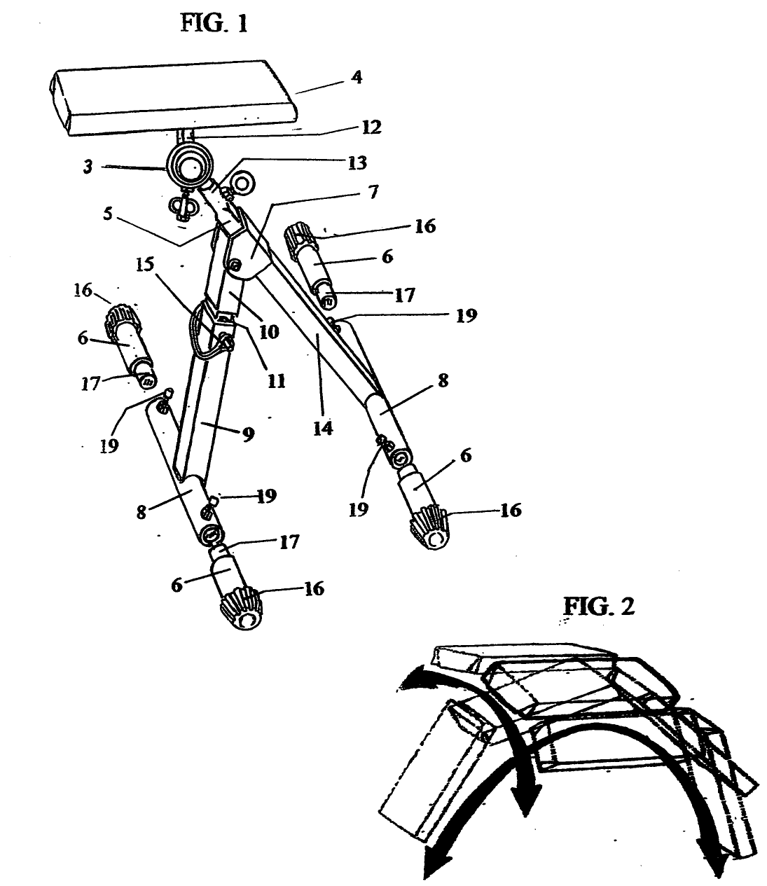

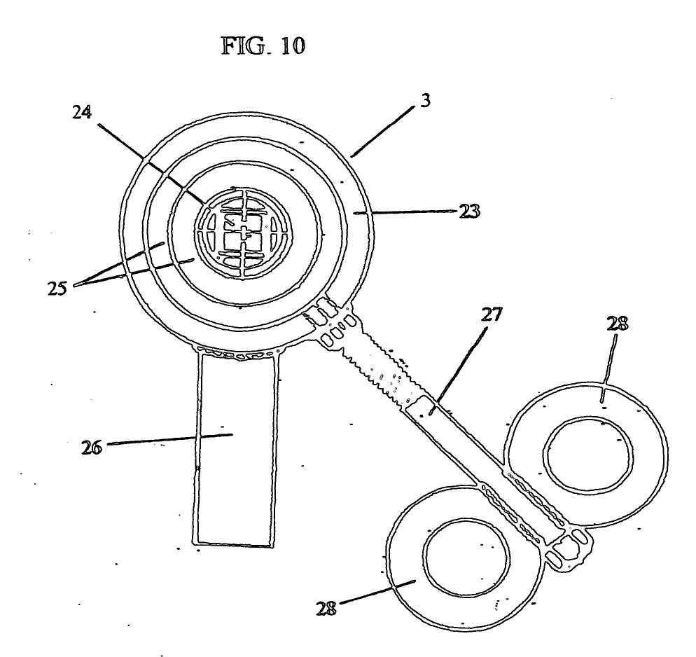

FIG. 1 is a view of the arm rest in its entirety. In FIG. 1, the pad 4 is mounted to a steel bracket 12, which is permanently fixed into the center of the ball swivel 3. This is one of the means by which the inventive arm rest can be used to tilt the pad to any angle required. The ball swivel 3, has a stem 26 attached at the bottom that isn't visible in this view. The stem 26 slides inside the collar 13. This is another inventive structure of the arm rest which allows the pad to be rotated 360 degrees and locked securely in place. The collar 13 is permanently fixed to the top of the steel square tube slide 5 which fills the entire length of the steel center vertical leg 14. This slide can be raised or lowered to any position required in accordance to the length of 5. The steel plate 7 is shaped to fit snuggly around the top section of 14 and is used as a hinge to attach the upper section 10, of the incremental adjusting leg. A length, of square tube 11, is drilled on both sides in even increments, to facilitate lengthening or shortening of this leg. 11, is equivalent in length to the combination of 9 and 10, 11 isn't visible in FIG. 1, but will be addressed in FIG. 9. Also, 11 is sized to fit into 9, which is drilled at the top to allow the use of a steel pin 15 to securely hold the desired height adjustment. The incremental adjusting leg is another inventive part since it allows the artist to fine tune the position which is best suited for each use. The horizontal leg extensions have a center section 8, which are drilled at both ends to accept threading or permanently fixing hardened nuts over the drilled holes. Allen bolts 19 or other threaded devices are used to securely hold removable horizontal leg extensions 6 in place. Rubber tips 16 are installed to prevent slipping or scratching floor. The removable horizontal legs are another inventive portion. Removal of the legs allows arm rest to set closer to a clients chair and improves ease in transport.

FIG. 2 illustrates the variety of arm rest pad angles that can be achieved and locked securely in place with the inventive ball swivel assembly 3.

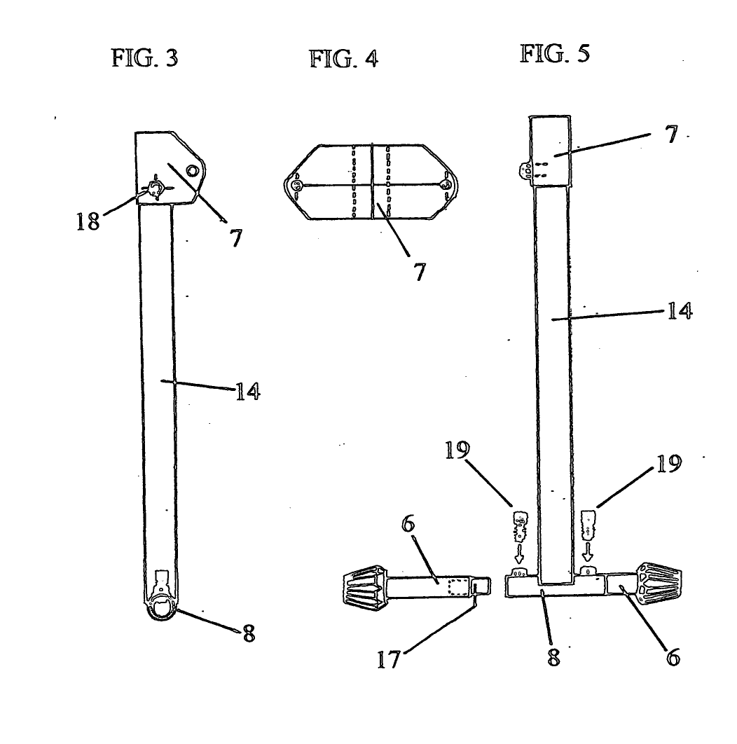

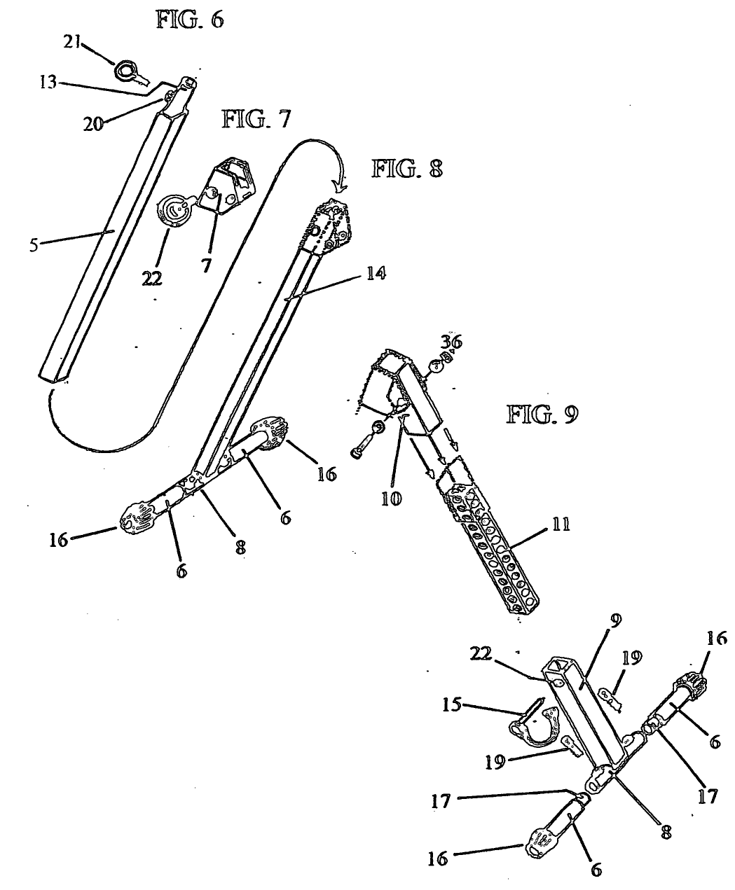

FIG. 3 is a side view of the center vertical leg 14. This shows the holes in 7 which are used to attach the upper section of the incrementally adjustable leg 11. This will allow the entire leg structure to be folded for transport. The steel hinge 7should be drilled and a hardened threaded nut 18 is permanently fixed over the hole. A hole is also drilled in 14 to allow the hardened threaded device 22, in FIG. 7 to pass through and apply pressure to 5, the steel square tube slide shown in FIG. 6. FIG. 3 also shows horizontal center section 8 side view where horizontal leg extensions 6 attach.

FIG. 4 illustrates the shape of the steel hinge 7 and placement of hinge holes before it is formed to fit the top section of 14 as seen in FIGS. 3 and 5.

FIG. 5 is the front view of the center vertical leg, it illustrates how the horizontal legs center section 8 should be permanently fixed to bottom of center vertical leg 14. FIG. 5 also shows one of the removable leg extensions 6, in place and one removed. All four leg extensions 6 have a length of solid steel round stock 17 that has been permanently fixed inside and an equal length protruding which has been sized to facilitate easy installation into center section 8. Allen bolts 19 are used to securely hold leg extensions in place.

FIG. 6 illustrates the square tube slide 5 which later be inserted into 14, the center vertical leg as shown in FIG. 8. In FIG. 6 the collar 13, made of round tubing is permanently fixed and shaped to have a smooth transition from the square tube 5 to the round collar 13. A hole is drilled in one side of the collar 13 and a hardened threaded nut 20 permanently fixed over the hole. A hardened threaded bolt 21 will be used to securely hold the stem 26, seen in FIG. 10 when arm rest has been assembled.

FIG. 7 illustrates the steel hinge 7 in its final shape along with threaded device 22 which is used to apply pressure on the square tube slide 5. Once assembled this creates a substantial vertical height adjustment.

FIG. 8 illustrates correct placement of 7, steel hinge. Also illustrates placement of horizontal leg extensions 6 with rubber tips 16 into horizontal legs center section 8.

FIG. 9 illustrates full assembly of the increment adjustable leg. A length of square tube 11 which has been drilled through the parallel sides in increments, must also be sized so a short section of 11 will fit tightly into square tube 10 and be permanently fixed. The remainder of 11 must slide freely in lower square tube 9. Lower square tube 9 must be drilled through parallel sides as shown, to align with holes previously drilled in 11, as shown. This incremental adjustment allows the arm rest to compact when needed and will securely lock in place with the use of 15, the steel pin. At this time, horizontal section 8 should be permanently fixed to the bottom of lower square tube 9. The bolt, washers and nut 36, will join FIGS. 8 and 9 at final assembly.

FIG. 10 is an enlarged view of the ball swivel 3. It consists of a collar 23, collar is drilled and a hardened nut is permanently fixed. Steel washers or tabs, 28 are permanently fixed to a hardened threaded bolt 27, which is equivalent in size to the threaded nut. Tabs 28, improve leverage when applying pressure to the hardened ball 24. The collar 23, encases the hardened ball 24. The ball 25 should be drilled through the center as shown before hardening. This hole will allow sturdy mounting of the pad bracket. A round stem 26, substantial in length to slide inside collar 13, shown in FIG. 6 of the vertical height slide 5, is permanently attached to the bottom of collar 23 of the ball swivel 3. This stem 26 will set inside collar 13 and allow 360 degree rotation of ball swivel 3 and arm rest pad 4.

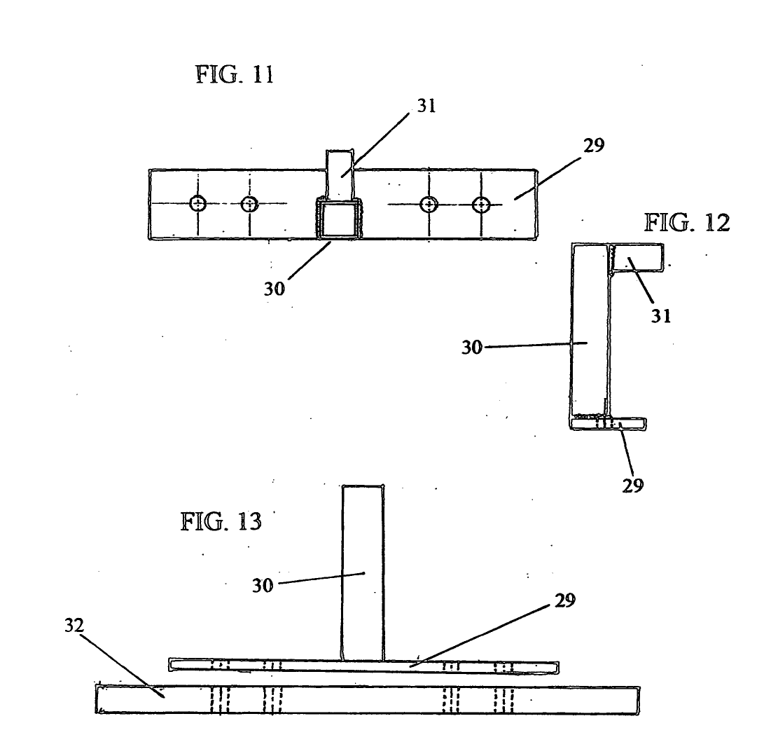

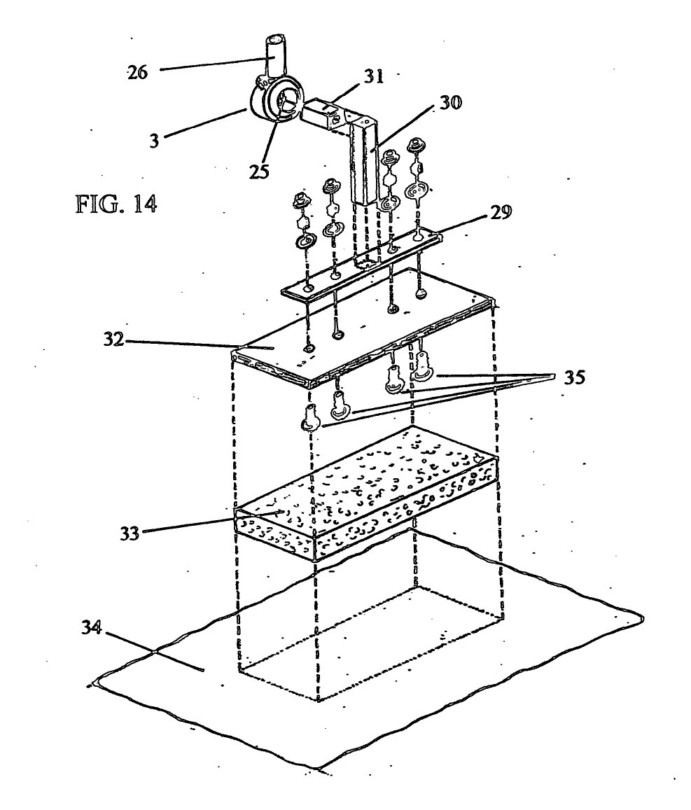

FIG. 11 is a top view of bracket for attachment of pad 4 as shown in FIG. 1 which attaches to ball swivel 3. The steel base plate 29 is drilled to allow mounting wood base 32 of pad 4 as shown in FIGS. 13, 14. Mounting holes should be equally distanced. 30 and 31 show proper placement when permanently fixed to steel base plate 29.

FIG. 12 illustrates square tubing 30 of adequate length permanently fixed to 31 at a 90 degree angle. 31 must be sized according to hole in center of ball swivel 3 as shown in FIG. 14. Once 30 and 31 have been assembled, 30 is permanently fixed to center edge of 29 as shown in FIGS. 12 and 14.

FIG. 13 illustrates holes drilled in center of wood base 32.where pad bracket assembly will mount.

FIG. 14 is illustration of pad construction with pad bracket and ball swivel assembly. At this juncture 31, 30 and 29 are assembled and now should be permanently fixed to ball swivel 3. 31 is inserted into hole, 25 as shown and permanently fixed. Bolts 35 are inserted from back side of wood base 32. Cushioning material 33 is cut to adequate size for wood base 32. A protective material 34 is used to cover and join cushion material 33 and wood base 32 together. Pad assembly, which consists of 32, 33, 34 and 35 as shown in FIG. 14 can now be fastened with hardware, to bracket 12 which consists of 29, 30 and 31 as shown in FIG. 14. Once assembled, the stem 26 will be inserted into collar 13 of square tube slide 5.

Our claim is,

1. A free standing arm rest for adjusting the height and angle required to assist a Tattooist in the comfortable application of a tattoo on a Clients arm, leg, or foot. Comprised of, a rest pad (4) permanently attached to the ball swivel (3) by means of a steel bracket (12), ball swivel can be angled to any position required and securely locked in place with the threaded device (27). Stem (26) which is permanently attached to the ball swivel, sets inside tubular collar (13) permanently attached and shaped to the vertical height slide (5) of vertical leg (14). This collar allows a 360 degree rotation of the rest pad to accommodate a precise location and can be secured with threaded device (21).

2. The mechanism as claimed in claim 1 includes a increment adjustable leg (11) which allows selective lowering and angle adjustment of leg (9). Said leg can be securely locked in place with steel pin (15).

3. The mechanism as claimed in claim 1 includes removable horizontal leg extensions (6) designed to be removed when positioning arm rest closer to clients chair or removal to facilitate ease in transporting arm rest. Leg extensions are securely held in place with threaded devices (19).
